(19) United States
(12) Patent Application Publication
(10) Pub. No.: US 2005/0125544 A1
(43) Pub. Date: Jun. 9, 2005

(54) Methods and apparatuses for facilitating online communications between parties

(76) Inventor: Yongjun Zhao, San Pedro City, CA (US)

Correspondence Address: TONG & ASSOCIATES, 5850 ANOGA AVENUE, SUITE #400, WOODLAND HILLS, CA, 91367, US

(21) Appl. No.: 11/004,680

(22) Filed: Dec. 2, 2004

Related U.S. Application Data
(60) Provisional application No. 60/528,100, filed on Dec. 4, 2003.
(60) Provisional application No. 60/622,116, filed on Oct. 25, 2004.

(51) Int. Cl. G06F 15/16

(52) U.S. Cl. 709/227

(57) ABSTRACT

Methods and apparatuses for facilitating online communications are described. One method comprises allowing at least one message author to compose a message; allowing the message author to provide a description of the message; defining a plurality of message types, each type distinguishable by its message description; associating the author's message with a message type from the plurality of defined message types; allowing at least one potential message recipient to enter a profile, the profile comprising an indication of the type of message the potential message recipient desires to receive; and, associating the author's message with at least one potential message recipient profile based on the message type. Another method comprises publishing a first message on at least one website; allowing an online subscriber to respond to the first message; posing a question to the online subscriber; allowing the online subscriber to answer the question; evaluating the online subscriber's answer; and allowing the online subscriber to see a second message depending on the success of the subscriber's answer.

### CROSS REFERENCE TO RELATED APPLICATIONS

This application claims priority to and incorporates by reference provisional application Ser. No. 60/528,100 filed on Dec. 4, 2003. This application further claims priority to and incorporates by reference provisional application Ser. No. 60/622,116 filed on Oct. 25, 2004.

### FIELD OF THE INVENTION

The present invention relates to computer programs, and in particular, computer programs that facilitate online communications between parties.

### BACKGROUND

Posting of Messages Online

Computer programs that allow computer users to post a message on the internet are known. For instance, many publishing companies allow companies and individuals to post a news release article on their websites. With reference to FIG. 1, these known computer programs allow a message author 10 to compose a message 11 and transmit the message 11 via a network 12, such as the internet, so that the public 13 may access the message. One problem with these computer programs is that they do not grant the message author the ability to control the dissemination of the message. Once the message is posted, anybody logged into the network can access the posted message. The message initiator cannot select the type of recipients able to receive the message. This is particularly problematic when the message includes private information.

Conventional E-Mail Programs

Currently existing e-mail programs, such as the program disclosed in Jain (U.S. Pat. No. 6,332,164) also allow users to post a message. Referring to FIG. 2, a message author 14 using an existing e-mail program typically composes a message 15, specifies the recipient's address 16, and transmits the message over the internet 17. The recipient 18, whose address is listed on the message, receives the message. At least two apparent problems are inherent with current e-mail programs, including the program disclosed by Jain. First, the message can only be distributed to the specified recipients. If the message author desires to broadcast a message to a large group, the author first has to collect the email addresses, and the author has to individually and manually type the email addresses to the program. A program that allows a message initiator to selectively send a message to one or more recipients without being required to specify an email address and without limiting the prospective recipients to only the identified recipients is desired.

Spam Control

The second problem with current e-mail programs is that recipients have little control over the type of e-mails they receive. The recipients are subject to receiving unwanted electronic mails (commonly called “spam”). Spam messages may contain viruses or may consume a computer's storage capacity. Jain appears to provide some control to the recipients over the messages they receive by sending only a portion of the author's message and allowing recipients to choose whether or not they want to receive the entire message. One problem with this approach is that the recipient may still receive messages that are infected with virus. Another problem is that the method in Jain appears to have a tendency to alter the content of the message. For instance, if the message contains more than one important idea, and the Jain system only picked and conveyed one of the many important ideas, the message and its impact to the recipient may be changed. A messaging system that allows recipients to better control the messages they receive than the system disclosed in Jain is desired.

Another e-mail program is disclosed in Council et al. (U.S. Pat. No. 6,587,550). Council et al. appears to provide some control to the recipients as to the messages they will receive by allowing recipients to impose a fee to the sending party, if the sending party is not on the recipients' authorized initiator list. One problem with the program in Council et al. is that some recipients might find valuable information from a initiator who might not necessarily be interested in paying. For instance, in a situation where the recipient is a person looking for a job and the initiator is a prospective employer, the prospective employer might not necessarily be interested in paying money to the recipient just to send the recipient an email. Thus, the recipient may miss out on some valuable messages. A program that grants recipients more flexibility than the program in Council et al. in controlling the messages they receive is desired.

Online People Search

Many websites allow users to search for people online. For instance, with reference to FIG. 3, these websites prompt users to fill out a form 19, which typically includes the first name, last name, and city and state of residence of the person to be searched. After users fill out the form, the form is transmitted via the internet 21 to the server 23. The server 23 typically has a database with stored user profiles. The server 23 processes the form 19 by matching the information provided on the form 19 with the stored user profiles. If there is a match, then the information that is stored in the database and that pertains to the person being searched is disclosed to the user.

At least one problem with these existing programs for conducting people search online is that the forms 19 are fixed. The user or the author is not allowed to modify the form or customize the form to make the search more effective. Thus, these programs are prone to providing overly broad or erroneous search results. Another problem is, from the profile owners' perspective, there is no way to control the distribution of their profile and the type of message they can receive. It is desired that profile owners have control over these matters so that potential profile owners may be encouraged to enter their profiles into the database.

Chat Programs

Many chat programs that allow people to have a typed, real-time, and online conversation are available. The parties interact as if they are chatting in front of each other because both parties instantly receive each other's written message. Each message 27A-E is rapidly transmitted over the internet or a network 21, and the dialog between the parties is displayed on each party's monitor 29 and 31. One problem with existing chat programs is that the parties have to type the words they want to convey. For some people who type slower than they speak, the quality of the chat is affected, as the conversation is slowed down. There are some of the phrases that are commonly used in day-to-day conversations, such as “hi” or “how are you?” It is desirable to have a chat program that provides a template of questions, words, or phrases, so that the parties only point their input devices to the template to make a selection of words to convey, instead of having to type every single word.

Conventional Internet Advertisements

Conventional internet advertisements include simple displays of advertiser's product description and contact information on a website, banner ads, pop-up ads, or hyperlinked phrases, which may link computer users to the advertiser's webpage. At least one problem with these forms of advertisement is that they provide no mechanism for advertisers to screen prospective customers or clients. When prospective customers or clients respond to the ads, the advertisers have to take each call from prospective customers or read and respond to each of their electronic mails. The task of screening phone calls or e-mails can be daunting, and thus advertisers desire to have an efficient way of screening those who respond to their ads.

From the perspective of consumers, at least one problem with conventional internet advertisements is that some advertisements only include general information about a product or service. For instance, they only include the name, address, and phone number of a service provider. If the consumer needs to ask specific questions about the services, the consumer may have to either call the advertiser or compose and send an email to the advertiser. The advertiser may not return the consumer's call right away. With regard to email, composing the message might be too time consuming, and the consumers might not ask the right questions. The advertiser may also use the email address of the consumer for other unauthorized purposes. Thus, conventional internet advertisements may be inefficient for consumers in terms for finding the right product or service provider. Conventional internet advertisements may also intrude on the consumers' privacy. It is desirable for the consumers to have the ability to screen conventional internet advertisers to shop efficiently and safely online.

Conventional Conferencing Equipment

Conventional conferencing tools exist to facilitate meetings or conferences of geographically separated parties. For example, videoconferencing equipment may be used to allow interviewers from States A and B to interview a job candidate from State C. Teleconferencing equipment may be used to allow a project team in State A to discuss overall status of a project with another project team located in State B. At least one problem with existing conferencing tools is they incur long-distance tolls, and they are inconvenient to arrange. For instance, one of the participants in a videoconference may have to install a video camera to his or her computer, login to a network, and wait for a connection. It is desirable to conference parties in a manner that is convenient, readily available, and does not incur long-distance tolls. It is also desirable for parties to have an opportunity to talk with other participants during the conference in at least a partially private manner and in a manner that prevents some of the participants from knowing the contents of the side conversation. Additionally, for conferences where evaluation is involved, such as a job interview where a job candidate will be evaluated by the interviewers, it is desirable to have a conferencing device that allows real-time evaluation and that includes a mechanism for at least partially automating the evaluation process.

### SUMMARY

Brief Description

The present invention includes a method for distributing an electronic message. The method includes allowing at least one message author to compose a message; allowing the message author to provide a description of the message; defining a plurality of message types, each type distinguishable by its message description; associating the author's message with a message type from the plurality of defined message types; allowing at least one potential message recipient to enter a profile, the profile comprising an indication of the type of message the potential message recipient desires to receive; and, associating the author's message with at least one potential message recipient profile based on the message type.

The present invention also includes a method for facilitating an online search. The method includes allowing at least one potential message recipient to enter a profile, the profile comprising at least one potential message recipient trait; compiling the potential message recipient profile; storing the potential message recipient profile into a database; allowing the author to compose at least one question and set at least one acceptable answer that corresponds to the question; inviting a potential message recipient to answer at least one question; allowing the author to answer at least one question; and, evaluating the potential message recipient's answer based on the acceptable answer.

The present invention further includes a method for conducting an online chat session. The method includes providing a network; allowing at least two parties to transmit data through the network; and, providing at least one message template to at least one of the two parties, wherein the party having access to the message template may select the template and transmit the template to the other party.

The present invention includes a method for facilitating online communications between parties comprising publishing a first message on at least one website; allowing an online subscriber to respond to the first message; posing a question to the online subscriber; allowing the online subscriber to answer the question; evaluating the online subscriber's answer; and allowing the online subscriber to see a second message depending on the success of the subscriber's answer.

The above description sets forth, rather broadly, a summary of the preferred embodiments of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims.

In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a schematic diagram of existing programs that allow computer users to broadcast a message online.

FIG. 2 is substantially a schematic diagram of existing programs that allow computer users to send an electronic message.

FIG. 3 is substantially a schematic diagram of existing programs that allow computer users to conduct a search for people online.

FIG. 4 is substantially a schematic diagram of existing programs that allow computer users to engage into a chat session with other computer users logged into a network.

FIG. 5 is substantially a schematic view of one embodiment of the message delivery system of the present invention.

FIG. 6 is substantially a flowchart depicting the steps preferably executed by the server and the author's computer during the initiation stage of the message delivery system.

FIG. 7 is substantially flowchart depicting the steps preferably executed by the server after the author sends the sender data to the server.

FIG. 8 is substantially a flowchart depicting the steps preferably executed by the server to schedule the delivery of the bottle to potential message recipient meeting the author's criteria.

FIG. 9 is substantially a flowchart depicting the steps executed by the server and the message recipient's computer after the recipient is selected to participate in the challenge session.

FIG. 10 is substantially a flowchart depicting the steps executed by the server and the author's computer during the configuration of the challenge session.

FIG. 11 is substantially a flowchart depicting the steps executed by the server and the author's computer to launch the challenge session.

FIG. 12 is substantially a flowchart depicting the steps executed by the server in conducting the challenge session.

FIG. 13 is substantially a flowchart depicting the steps executed by the server and the challengee's computer during the challenge session.

FIG. 14 is substantially a schematic view of one embodiment of the message delivery system of the present invention.

FIG. 15 is substantially a schematic view of one embodiment of an online chat system of the present invention.

FIG. 16 is substantially a schematic view of yet another embodiment of the message delivery system of the present invention.

FIG. 17 is substantially a flow chart to be executed by the message delivery system embodiment shown in FIG. 16.

FIG. 18 is substantially a flow chart configured to be executed by a respondent that uses the message delivery system embodiment shown in FIG. 16.

FIG. 19 is substantially a flow chart configured to be executed by the message delivery system embodiment shown in FIG. 16.

FIG. 20 is substantially a front view of a display that is preferably viewable by a prospective message recipient.

FIG. 21 is substantially a front view of another display that is preferably viewable by a prospective message recipient.

FIG. 22 is substantially a front view of another display that is preferably viewable by a prospective message recipient.

FIG. 23 is substantially a front view of a display that is preferably viewable by an author after a prospective message recipient provides a valid code in response to the author's message.

FIG. 24 is substantially a schematic view of an online conferencing device embodiment of the present invention.

FIG. 25 is substantially a front view of another display that is preferably viewable by a pre-selected group of meeting participants using the online conferencing device of FIG. 24.

FIG. 26 is substantially a front view of another display that is preferably viewable by an addressed participant using the online conferencing device of FIG. 24.

FIG. 27 is substantially a flow chart configured to be executed by the online conferencing device of FIG. 24.

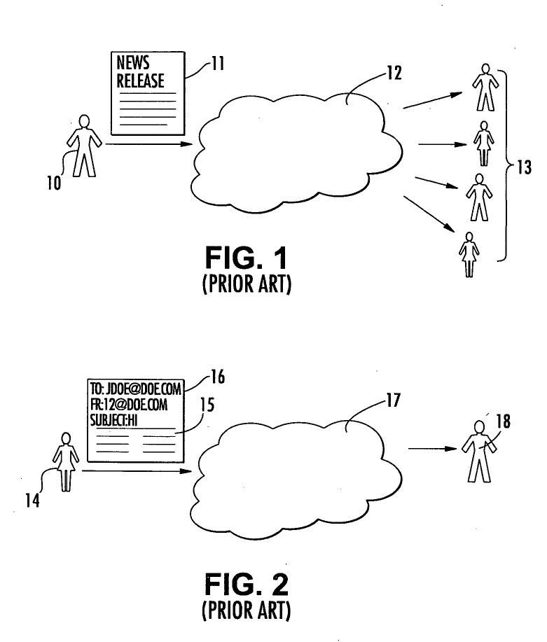

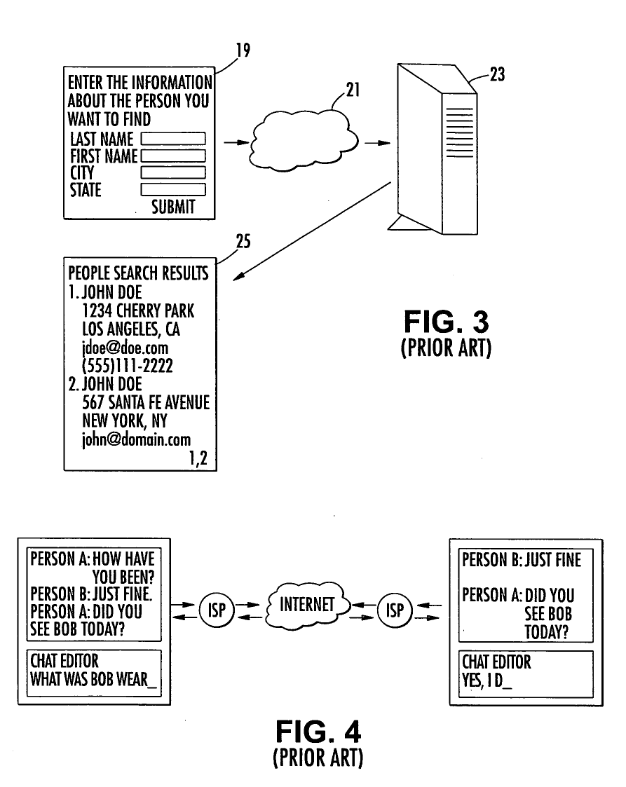

### DETAILED DESCRIPTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

As used herein, the term “internet” may interchangeably used with the term “network” to refer to a communication system that allows users to connect computers, terminals, or databases. The term “server” may interchangeably be used with the term “computer” to refer to an electronic device or a plurality of connected electronic devices that can store, retrieve, or process data or that can provide service for connected computers. The term “message” may be used to refer to a communication in writing or by signals. The “message” may be in a form of a word, a phrase, a sentence, a paragraph, or a piece of information that conveys an idea, thought, or expression.

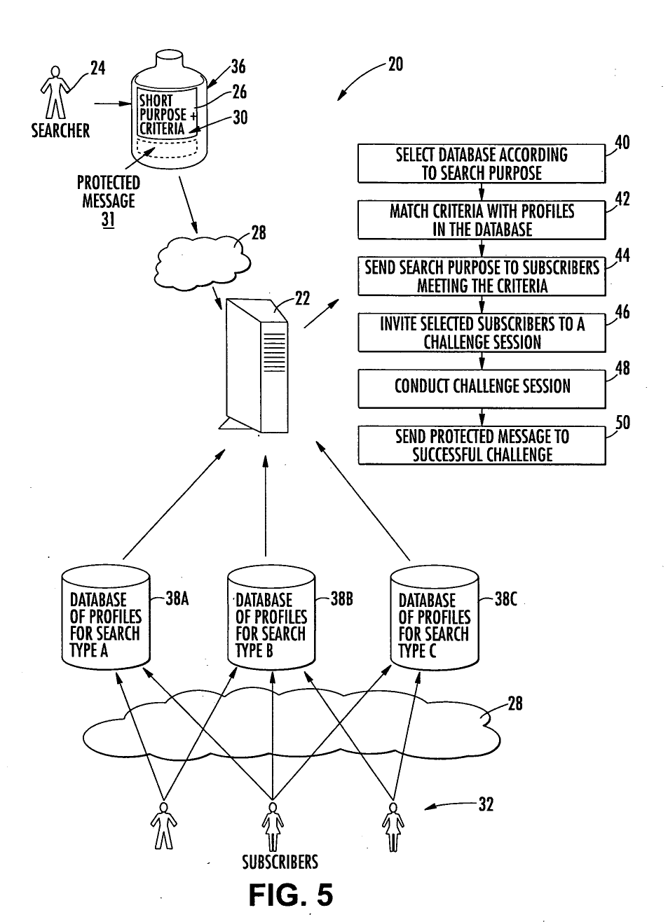

The present invention comprises a message delivery system (MDS), generally indicated by reference number 20. MDS 20 can be implemented on one server 22, a plurality of servers (not shown), or on one or a plurality of computers (not shown). Referring to FIG. 5, MDS 20 preferably allows a message author 24 (hereinafter “author”) to use a computer (not shown) and connect to the internet 28 preferably using an internet service provider (ISP). The term “message author” may interchangeably be used with the terms “message initiator” and “message sender” and is used to refer to a source of a message regardless of the originality of the message. The message author is preferably the one who introduces the message to MDS 20. Author 24 may specify on the computer the type of search the author desires or the purpose of the search 26, the criteria for finding the person or item 30, and at least one protected message 31.

The search purpose 26 may be, as examples, to find a prospective employee, a business partner, a romance partner, or a long lost relative or friend. The protected message 31 may be an employment contract for the prospective employee to sign, a contract for the business partner to execute, a contact information for a long lost relative or friend, a reward for the long lost relative or friend for initiating the contact with the author, a meeting place and time for a prospective romance partner, or simply the identification of the author. It can be appreciated that MDS 20 allows authors to customize their searches by allowing them to define their search purpose and criteria for screening the potential recipients of their messages.

The data that author 24 enters into the computer 26A may collectively be referred to as “author data.” The way MDS sends the author data may be analogized to sending the data using a virtually sealed bottle 36 wherein the search purpose 26 and criteria 30 are printed on the bottle label that is visible to the recipient, and the protected message 31 is placed inside the sealed bottle. The author data may be transmitted through the internet 28 and stored into the server 22.

Next, MDS 20 may allow a plurality of potential message recipients 32 (hereinafter “PMRs”) to use their computers and connect to the internet 28. The term “potential message recipient” may interchangeably be used with the terms “bottle recipient” and “subscriber” to refer to computer users who may receive information or message from the message author. PMRs 32 may enter their personal profile, such as their names, dates of birth, eye color, hair color, height, weight, likes, dislikes, addresses, and the like. PMRs 32 may also enter the types of searches they want to participate in, such as a search for a prospective employee, a search for a long lost relative, a search for a business partner, a search for a romance partner, and the like.

The data the PMRs enter into the computer may collectively be referred to as PMRs' profile. The PMRs' profile may be sorted according to the type of searches the particular PMR indicated he or she will participate. Each PMR may participate in more than one type of search, and thus one PMR's profile may be multiplied and classified under a plurality of search categories. The PMRs' profile may be transmitted through the internet 28 and stored into the server 22. It is noted that MDS 20 preferably allows PMRs to choose the type of information that they enter into the database, and thus allows provides the system the flexibility in conducting the search for prospective recipients, which, in turn, results to an effective method for controlling the distribution of the sender data.

The PMRs' profile may be sorted according to search categories and may be stored in their appropriate databases 38A, 38B, and 38C. For example, database 38A may be for PMRs who have indicated they want to be considered when the author is searching for a prospective employee; database 38B may be for PMRs who have indicated they want to be considered when the author is searching for a prospective business partner; and, database 38C may be for PMRs who have indicated they want to be considered when the author is searching for a prospective employee.

With continued reference to FIG. 5, MDS 20 preferably employs a program that is configured to execute all or some of the following steps, not necessarily occurring in any particular order: select at least one database according to the search purpose 26 (step 40); match the criteria 30 with the PMR profiles in the corresponding database 38A, B, or C (step 42); send the search purpose to PMRs meeting the criteria 30 (step 44); invite the selected PMR to a challenge session described below (step 46); conduct the challenge session (step 48); and, allow the successful challengee to open the bottle 36 and access the protected message 31 (step 50).

It can be appreciated that, with certain embodiments of the MDS of the present invention, a message author can send a message to an unlimited number of potential recipients without specifying an exact destination or e-mail address. It can further be appreciated that MDS 20 helps PMRs prevent unwanted electronic mails or spam because the MDS can be configured to send only the message, which has a search purpose that matches the type of search the recipient has indicated. Additionally, the MDS further maintains the privacy of the message, as the MDS can be configured to only grant access to the PMR who successfully answers the questions in the challenge session.

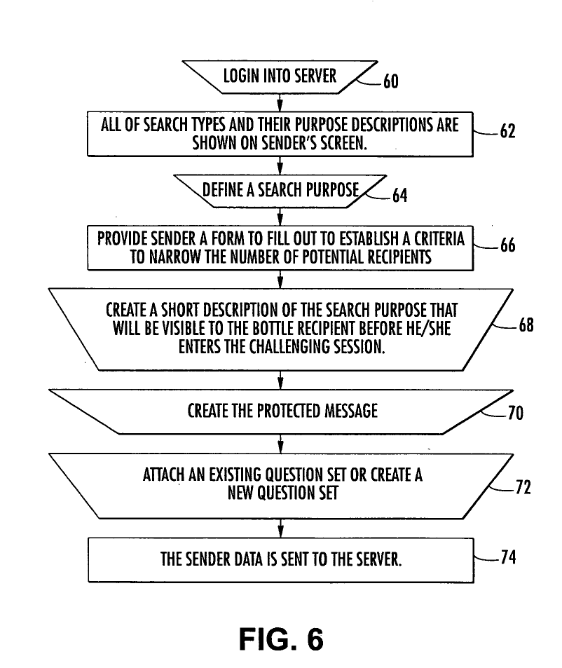

With reference now to the subsequent figures, FIGS. 6-13, a detailed description of the preferred implementation of the will be provided. The order in which the steps are presented below is not limited to any particular order and does not necessarily imply that they have to be performed in the order presented. It will be understood by those of ordinary skill in the art that the order of these steps can be rearranged and performed in any suitable manner. It will further be understood by those of ordinary skill in the art that some steps may be omitted or added and still fall within the spirit of the invention.

Initiating the Search

Referring now to the flowchart shown in FIG. 6, for the message initiator to initiate the search, the message initiator preferably first logs into the server at step 60. The system may be set-up so that the log in process is automatic. Alternatively, the log in process may be omitted. The server preferably has stored a variety of search types or a list of various search purposes, which the server may display on the message initiator's computer at step 62. Alternatively, message initiators may create their desired search purpose. The system preferably prompts the message initiator to define at least one search purpose at step 64.

At step 66, the message initiator may be presented with a form, which the initiator can fill out to establish a criteria. The criteria may be used to narrow the PMR pool from a PMR database, as described above. Next, at step 68, the initiator is preferably prompted to compose a note, which will be displayed to the bottle recipient and may be used by the bottle recipient to make a decision on whether to continue participating and whether to enter into the challenge session, which will be described in detail below. As examples, the note may contain general information about a job opening, such as the job title, job description, salary, and benefits. The note may also be a description of a person or an opportunity.

At step 70, the initiator may be prompted to compose the protected message, which may be displayed to the bottle recipient who successfully completes the challenge session. Depending on the type of search, the message may be a job offer to the successful PMR, a contract for a business partner, a contact information for the long lost relative or friend to use, a reward for the long lost relative or friend for initiating the contact with the initiator, or a meeting place and time for the prospective romance partner, or a initiator identification. At step 72, the initiator may upload a list of questions, their corresponding answers, and their evaluation protocol, which may be used during the challenge session, which is further described below. At step 74, the bottle may be transmitted from the initiator's computer to the server via the internet.

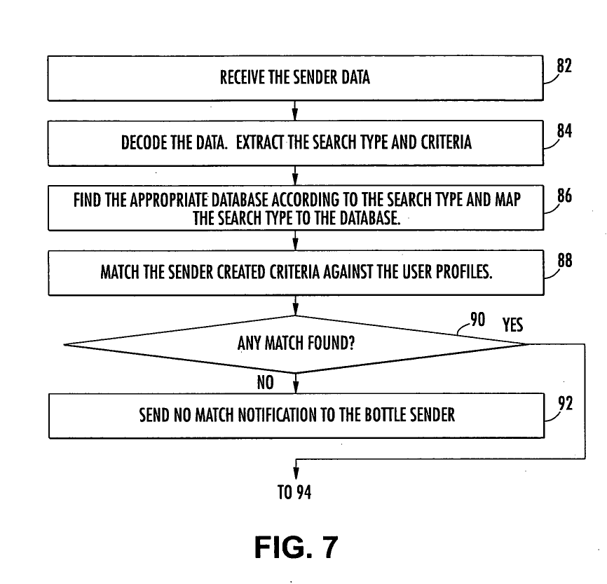

Referring now to FIG. 7, once the server receives the initiator data or bottle, the server preferably operates to narrow the pool of PMRs. When the server receives the bottle, the server is preferably configured to decode at least a part of the initiator data at step 84, preferably the part of the data regarding the search type, which is preferably derived from the description of the search purpose and the criteria the message author has composed. The server may then map the message type to the corresponding PMR profile database at step 86. At step 88, the server is preferably configured to match the initiator created criteria against the stored PMR profiles. At step 90, the server preferably determines whether there is a match. If there are no matches, the message author is preferably notified at step 92.

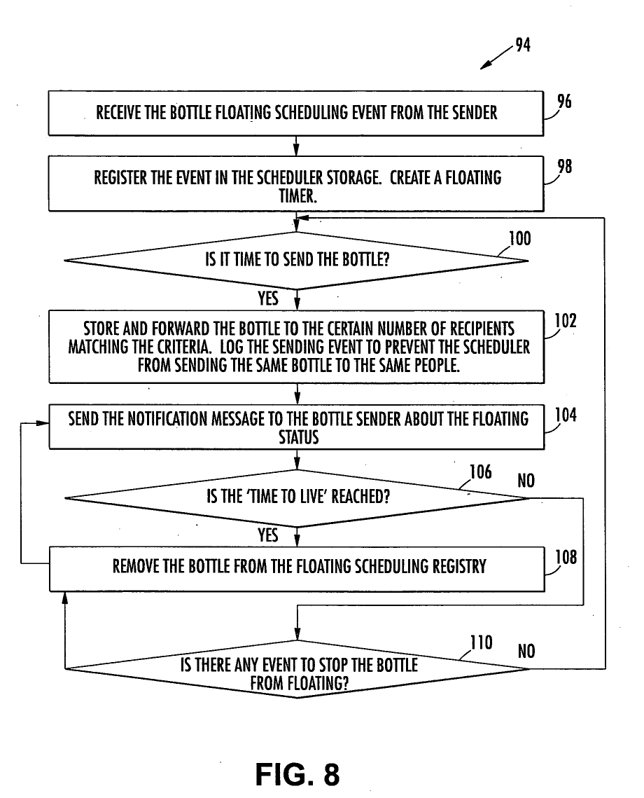

If there is a match, the server preferably follows the floating scheduler protocol 94 in FIG. 8. The floating scheduler protocol preferably provides the server a set of instructions to determine whether the transmission of the message purpose description should be postponed (also referred to as keeping the “bottle floating”) to wait for additional PMRs who may meet the criteria, or to proceed with the transmission of the message purpose description to the qualified PMRs. At step 96, the message author preferably sets the events that would trigger the release of the message purpose description. The events may be in the form of the number of PMRs that match the author criteria, duration of time, and the like. For instance, the author may indicate that if the number of qualified PMRs is less than ten (10), then the server may be instructed to stop the floating of the bottle and send the bottle to the qualified PMRs. As an alternative example, the sender may instruct the server to keep the bottle floating or postpone the transmission of the bottle to the qualified PMRs for two (2) days after the server received the bottle.

At step 98, the event is preferably stored in the scheduler storage, and for every message type defined by the message purpose, a timer is preferably initiated based on the event definition from step 96. The server preferably uses the timer to determine whether it is time to send the bottle at step 100. If it is time to send the message purpose or the bottle, the message purpose may be forwarded to the PMRs that met the criteria (step 102), and the occurrence of the event may be logged into the server so that the server may not send the same bottle to the same PMRs again. It is noted that when the bottle is sent, the recipient preferably can only see the bottle label, which preferably has the search purpose description. The recipient is preferably denied access to the protected message inside the bottle at least until after receiving a favorable outcome in the challenge session. At step 104, the message sender may be notified that the message purpose description has been sent to the qualified PMRs.

Each floating bottle preferably has a shelf-life or a “time to live” feature, wherein if the sending event never occurs, the bottle is scheduled to be removed from the floating scheduler. At step 106, the server checks whether the message purpose or the bottle is expired. If it is expired, the bottle is preferably removed from the floating scheduler at step 108. The message author may be notified of this removal. Other events may be added that would cause the bottle either to be sent to qualified PMRs or removed from the floating scheduler. At step 110, the server preferably checks for these events to make sure no bottles are left in the scheduler unattended.

Compiling Potential Message Recipient Profile

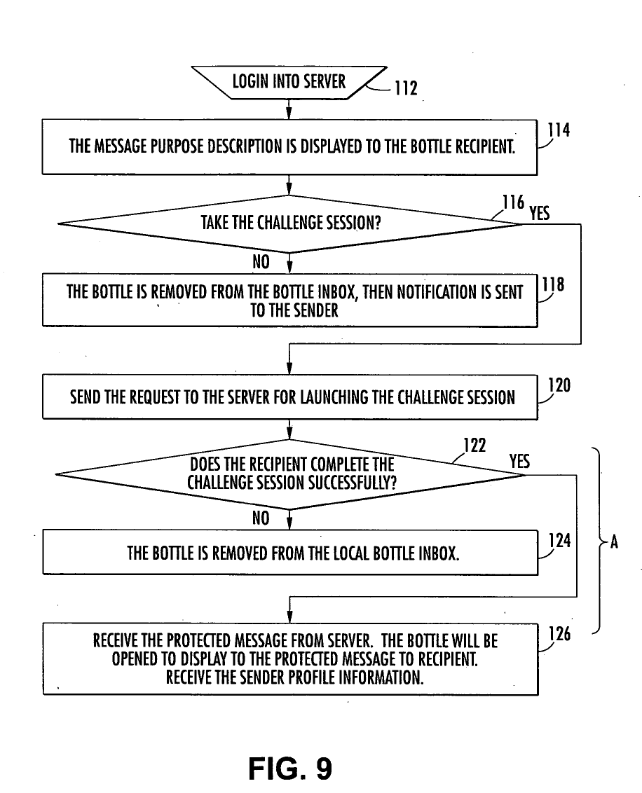

Referring now to FIG. 9, when a subscriber logs into the server (step 112) and when the subscriber's profile meets the criteria set by the initiator, the PMR preferably receives the message purpose (step 114). The PMR is then prompted whether he or she wants to take the challenge session (step 116). If the PMR indicates no, the message purpose or the bottle is preferably removed from the bottle inbox of the PMR, and the initiator is preferably notified (step 118).

If the PMR indicates that he or she wants to take the challenge session, a request to launch the challenge session is preferably sent to the server (step 120). The challenge session may be conducted as will be described below, and the server determines whether the PMR successfully completed the challenge session (step 122). If the PMR failed the challenge session, then the message description or bottle is preferably removed from the PMR's inbox (step 124). Alternatively, the message initiator can be notified of the PMR's failure before the bottle is removed from the PMR's inbox, and the message initiator may revise the question to adjust the difficulty of the question thereby giving the PMR another chance to succeed in the challenge session. The number of chances given to the recipient to succeed in the challenge session may vary. If the PMR succeeds in the challenge session, the PMR preferably receives the protected message from the server, which is preferably secured in a virtual container or bottle, thereby being able to access the message in the bottle (step 126). The successful PMR may further receive the profile of the initiator. Alternatively, the profile information of the initiator and the PMR may be exchanged to each other. It is noted that the initiator profile may be a profile of an individual or a company.

Challenge Session

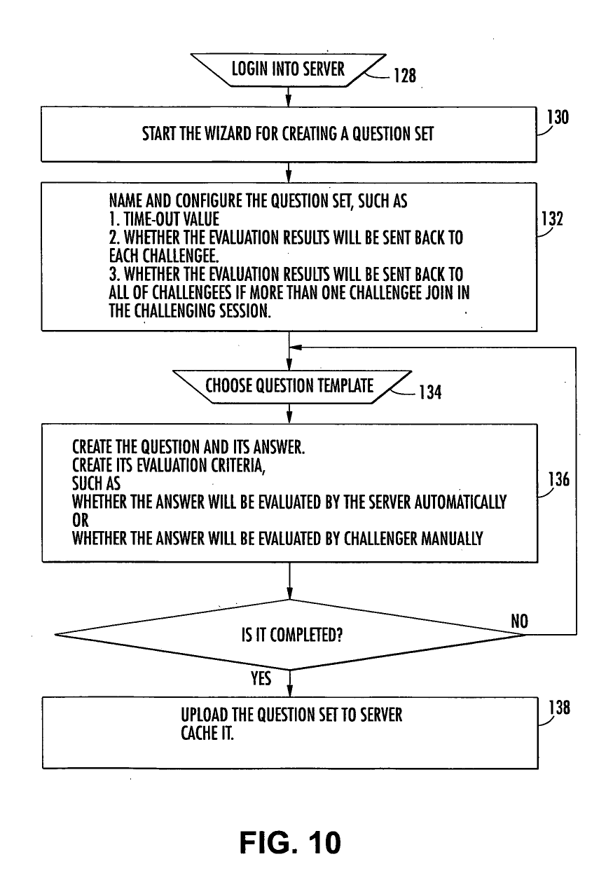

With reference now to FIG. 10, the challenge session may be conducted as follows. The initiator may log in to the server (step 128). The server may provide the initiator with a “wizard” or an interactive help utility that guides the initiator through the challenge session set-up process (step 130). At step 132, the wizard may require the initiator to name and configure a question set. For instance, the wizard may ask the initiator to provide a time-out value or a period of time or event after which an error condition is raised. The server may also ask the initiator to indicate whether the evaluation results will be sent back to each PMR. The server may further ask the initiator to indicate whether the evaluation results will be sent back to the entire participating PMR if a plurality of PMRs participated. Additional configuration parameters may be posed to the initiator.

Next, at step 134, the wizard may provide a template of questions from which the initiator may choose. Alternatively, the initiator may create a question and the corresponding answer (step 136). The initiator may configure an evaluation method for the question, which may be an automatic evaluation by the server or a manual evaluation by the initiator. It is noted that automatic evaluation may be useful if the initiator uses the already existing question template, and the initiator does not have sufficient knowledge to evaluate the answer. For instance, in a scenario involving a search for a job applicant, the challenge session may be configured by a person from an information technology department, and the initiator may be an employee from the human resources department acting as an end user. The initiator may not have sufficient knowledge on how to evaluate the answer, and the program may best be configured to allow the software to automatically evaluate the answer. Another scenario where automatic evaluation may be useful is when the initiator conducts multiple challenge sessions at one time. To have a real-time challenge session, the program may best be configured to automatically evaluate the answers.

Once the initiator is finished with the set-up process, the initiator may upload the question set to the server (step 138). The question set may be cached at the local initiator computer so that the local computer does not have to retrieve the questions from the server. The question set stored at the server may allow the initiator to download the question set from a different computer. For example, the initiator may upload the question set using a computer from his or her office. The initiator may then download the question set from the server using a computer from his or her home.

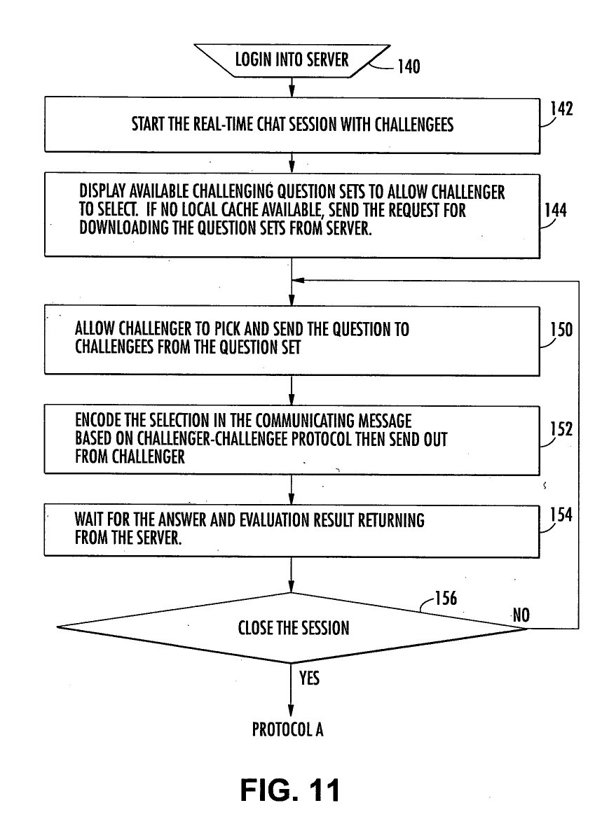

Referring now to FIG. 11, at least one participating PMR, now referred to as challengee may launch the challenge session by logging into the server (step 140) and starting a real-time chat session with the initiator, who is now referred to as the challenger (step 142). The challenge session may run concurrently with the chat session. At step 144, the question sets may be displayed to the challenger, and the challenger may be allowed to select questions from the sets to pose to the challengee. If the question sets are not cached, then the question sets may be downloaded from the server. At step 150, the challenger may pick from the question set. It can be appreciated that in the chat session of this preferred embodiment, the challenger may not be required to create a question from scratch. That is, the challenger may not need to formulate questions, type, and save the questions. Instead, the challenger may simply point his or her mouse or input device to the desired question, clicks, and transmits the selected question to the challengee.

At step 154, the challenger preferably waits for the answer from the challengee and evaluation result from the server. If the challenger configured the challenge session so that the challenger manually evaluates the answer, then the manual evaluation step may be executed. Next, depending on whether there are additional questions or whether the challenger wants to revise the questions, the server decides whether to continue or close the challenge session at 156. If the server is instructed to continue the challenge session, then the protocol preferably loops back to step 150. If the server is instructed to close the challenge session, the server executes protocol A, which includes steps 122, 124, and 126 shown in FIG. 9.

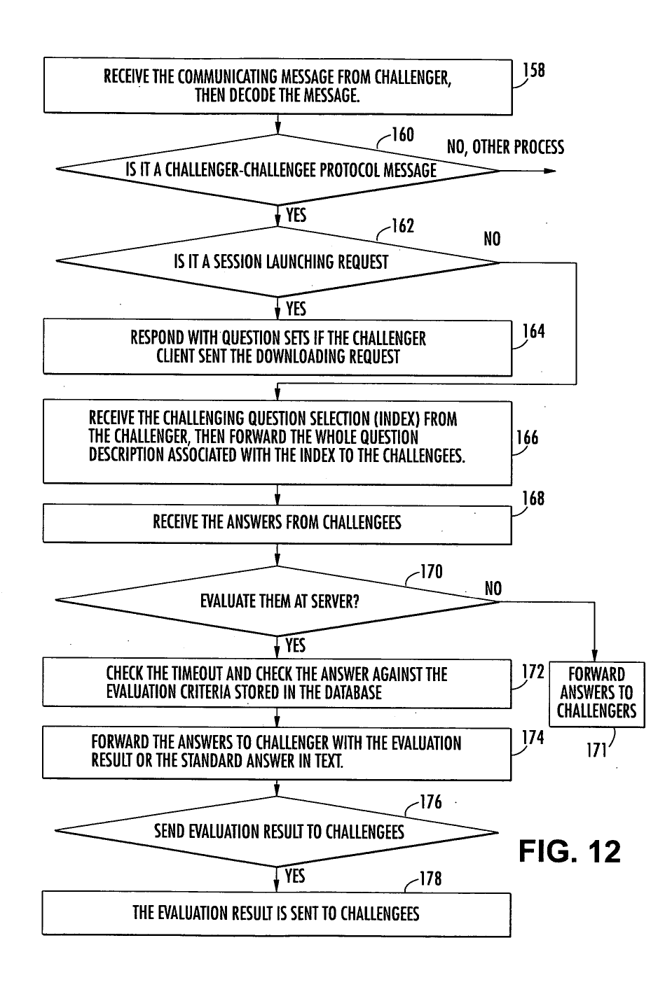

The steps executed from the server side during the challenge session will now be described. Referring now to FIG. 12, the initiator may first receives the initiator data from the challenger and decodes the data. The server looks for a challenge session signal at step 160. If it detects the challenge session signal, the server preferably waits for a challenge session launch request at step 162 and preferably launches the challenge session upon receiving the request. The server may then download any questions, if requested (step 164).

At step 166, the server preferably receives the question selection from the challenger and forwards the question to the challengee. At step 168, the server preferably receives the answers from the challengees. The server reads the instruction on whether to evaluate the answers at step 170. If the instruction is not to evaluate the answer, then the server forwards the answers to the challenger at step 171. If the instruction is to evaluate the answer, then the server preferably checks the timeout setting and the answer against the evaluation criteria that is stored in the database at step 172. At step 174, the server forwards the answers to the challenger with the evaluation result. Alternatively, the server also forwards the challengee's answer to the challenger. At step 176, the server preferably checks for instruction on whether to send the results to the challengee. Once the server obtains the instruction, it preferably sends the evaluation results to the challengee at step 178.

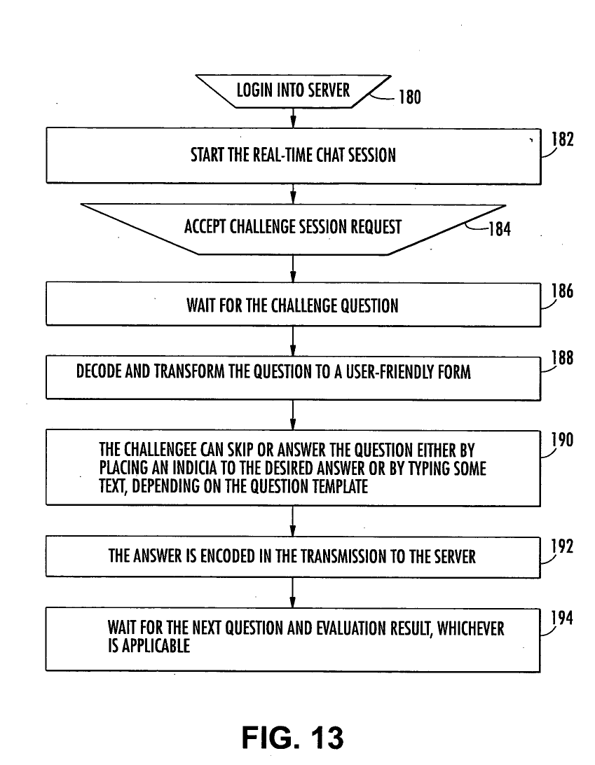

The steps executed by the server and the challengee's computer during the challenge session will now be described. Referring now to FIG. 13, when the challengee logs into the server at step 180, the server preferably starts a real-time chat session between the challenger and the challengee (step 182). If the challengee accepts an invitation to a challenge session at step 184, the server preferably sends the questions to the challenges and the challenge receives the questions (step 186). The questions may then be decoded and transformed into a user-friendly form (step 188). At step 190, the challengee can skip or answer the question either by placing an indicia to the desired answer or by typing some text, depending on the question template. The answer may then be encoded during the transmission to the server at step 192. The challengee may wait for the next question or the evaluation result, whichever is applicable (step 194).

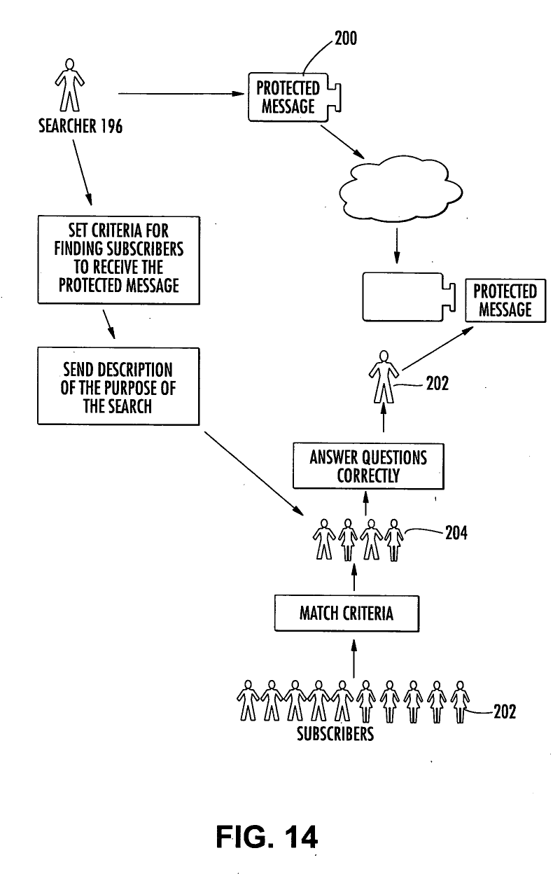

Referring to FIG. 14, it can now be realized that certain embodiments of the present invention allow a message initiator 196 to send a message to an unlimited number of potential message recipients 202 without specifying an exact destination or e-mail address. It can further be appreciated that certain embodiments of the present invention protect the privacy of a message 200 by granting access to the message 200 only to the PMRs who successfully answers the questions in the challenge session 202. Next, certain embodiments of the present invention help PMRs prevent unwanted electronic mails or spam by allowing PMRs to define the type of message they want to receive, classifying each outgoing message, and sending the message only to the recipients who have indicated interest in receiving that particular type of message 204.

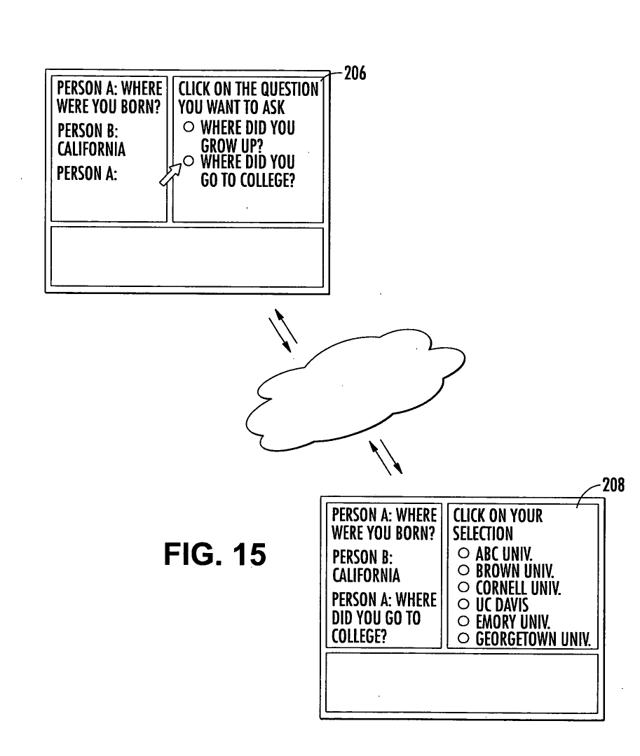

Referring to FIG. 15, it can further be realized that certain embodiments of the present invention provide a chat session wherein the participants are provided templates of questions 206 or answers 208. Thus, the participants may not be required to create a question or answer from scratch. The participants may not need to formulate nor type the questions or answers. Instead, the participants may simply use their input devices, such as a mouse or keyboard, and select from the template of questions or answers. It can be realized that with this feature, participants can have a more dynamic and real dialog. The waiting time involved in between messages is minimized. Additionally, with certain embodiments of the present invention, the participants may be able to pose more questions or may have more conversation topics.

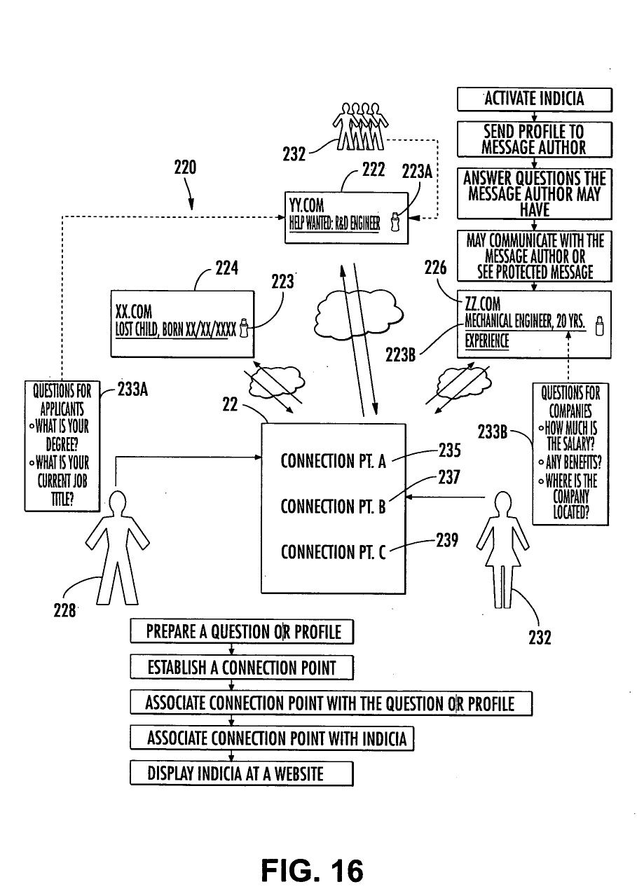

With reference now to FIG. 16, another embodiment of MDS, which is indicated by reference number 220, is shown. MDS 220 preferably includes a server 22 that may be connected to a plurality of websites 222, 224, and 226. An author 228 may prepare at least one question 233A to be used for screening potential message recipients (PMRs) 232 visiting the plurality of websites 222, 224, and 226. The author may then establish connection point, which is preferably a common reference point through which an author and a PMR may communicate. The question 233A is preferably associated with the connection point, which may subsequently be associated with an indicia 223A. The indicia 223A may then be displayed at a website 222, 224, or 226. The indicia 223A is preferably related with the question associated with the connection point. For instance, as shown in FIG. 16, indicia 223A states: “Help Wanted: R& Engineer,” and question 233A includes questions for job applicants, including the type of baccalaureate degree of the applicant and the current job title of the applicant.

At least one PMR 232 may activate an indicia 223A. A PMR's pre-established profile may be sent to the message author upon activation of the indicia. The PMR 232 may also have to answer the questions the author 228 may have before the PMR 232 may be able to communicate with the author or before the PMR 232 may obtain the information he or she seeks. In the example shown in FIG. 16, PMR 232 may have to state his or her type of baccalaureate degree and his or her current job title before the PMR 232 can communicate with the message author, who may be an employer, or before the PMR 232 may obtain more information about the job being offered.

With continued reference to FIG. 16, it is noted that MDS 220 allows anybody connected to a network, such as the internet, including any PMR, to be a message author. Examples of authors may include: recruiters advertising a job opening; job applicants advertising their background and availability, which is similar to a conventional situations wanted ad; single people looking for a date; and, people looking for certain persons. Thus, in FIG. 16, a PMR 232 may also prepare a question; establish a connection point, which may be associated to the question and an indicia; and the indicia may be displayed at a website. In the example shown in FIG. 16, a PMR 232 looking for an employer may prepare a question 233B inquiring about the salary, company benefits, company location, and the like. The question 233B may be associated with a connection point B, and any potential employer connected to the network may click on this PMR's indicia 223B. The potential employer may then answer PMR 232's questions. If the potential employer's answer is acceptable to PMR 232, then both parties may communicate or the potential employer may see PMR 232's profile.

It is further noted that the server 22 may have a plurality of connection points, such as connection points 235, 237, and 239. Each connection point may be distinguishable by their search purpose. For example, connection point A may be for businesses to find employees; connection point B may be for individuals to find jobs; and connection point C may be for individuals looking for a lost person.

At least some of the questions or profile that is associated with a connection point may also be moved from one connection point to another. This feature may be useful where two connection points have very similar search purposes. For example, a connection point A may be for posting a photo album for invited people to see. Connection B may be for single people looking for a date. A profile used for connection point A may be used as a profile for connection B should the author, who established connection A, be interested in looking for a date using connection B.

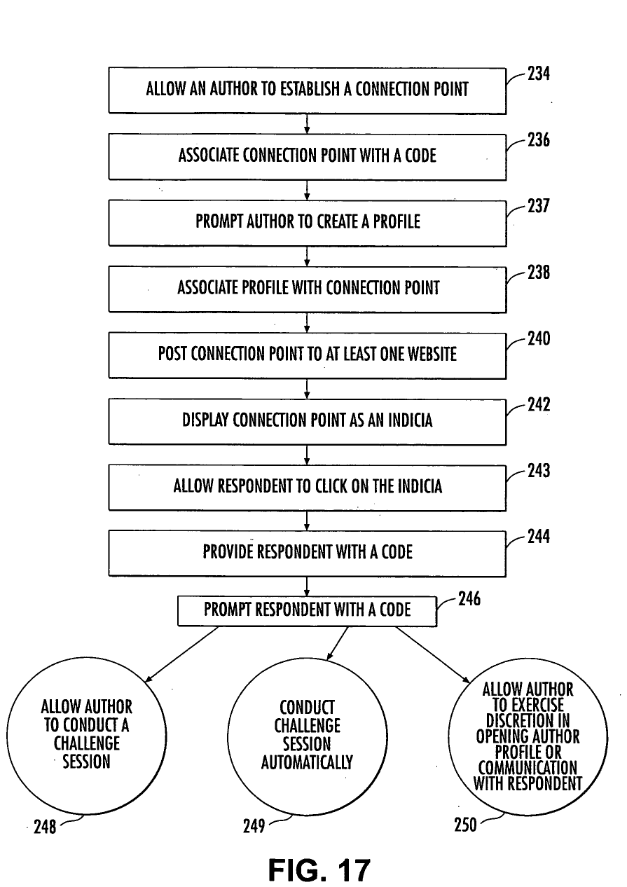

With reference now to FIG. 17, MDS 220 is preferably configured to execute the steps. At step 234, MDS 220 preferably allows the author (not shown) to establish a connection point. The term “connection point” refers to a common reference point through which an author and a PMR may communicate. The new connection point is preferably associated with a code, which preferably bears a user identifying data (step 236) to allow MDS 220 to confirm the identity and authority of the PMR to proceed. At step 237, the author is preferably prompted to enter certain information that may be information of benefit to the eventual message recipient.

For example, the profile may include the job title, the job duties, the work hours, the salary, commissions or bonuses, benefits, qualifications, requirements, and contact information of the recruiter, all of which may be useful to a job applicant. If the author is a job candidate trying to attract employers, the profile may include the candidate's list of qualifications, resume, evidence supporting the qualifications, such as articles or awards, and search terms that may help recruiters find the applicant from the plurality of job applicants.

Next, PMR profile information is preferably associated with the connection point at step 238. At step 240, the connection point is preferably posted to at least one website, and the connection point is preferably displayed as an indicia (step 242). Internet or online subscribers may activate the indicia when visiting at a website (step 243). These subscribers will now be referred to as “respondents.” At step 244, each respondent is preferably provided with a code that is preferably compatible with the code from step 236. The respondent will preferably be prompted to enter the code (step 238). If the code is determined to be compatible with the code from step 236, MDS 220 may either allow the author to conduct the challenge session ( step 248), conduct the challenge session automatically (step 249), or allow the author to exercise discretion in granting the PMR access to the author profile or in opening communication lines between the author and the respondent (step 250).

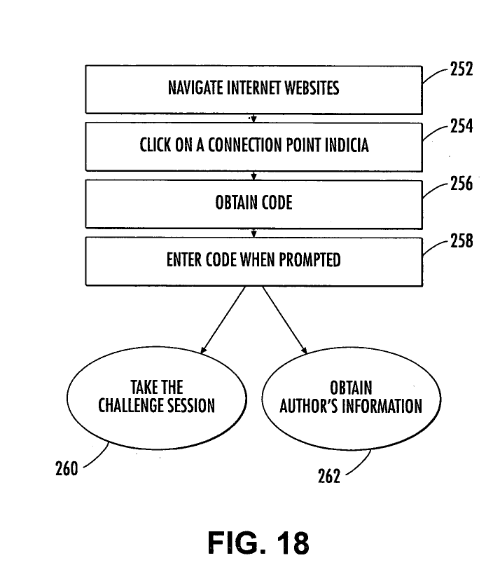

FIG. 18 shows the steps a respondent may execute when using MDS 220. As respondent navigates through various websites on the internet (step 252), the respondent may find and activate a connection point indicia (step 254). The respondent may receive a code (step 256), which the respondent may enter when prompted (step 258). If the code is accepted by MDS 220, the respondent may take a challenge session (step 260). Alternatively, the respondent may receive information pertaining to the author, preferably including a contact information, which the respondent may use to contact the author (step 262).

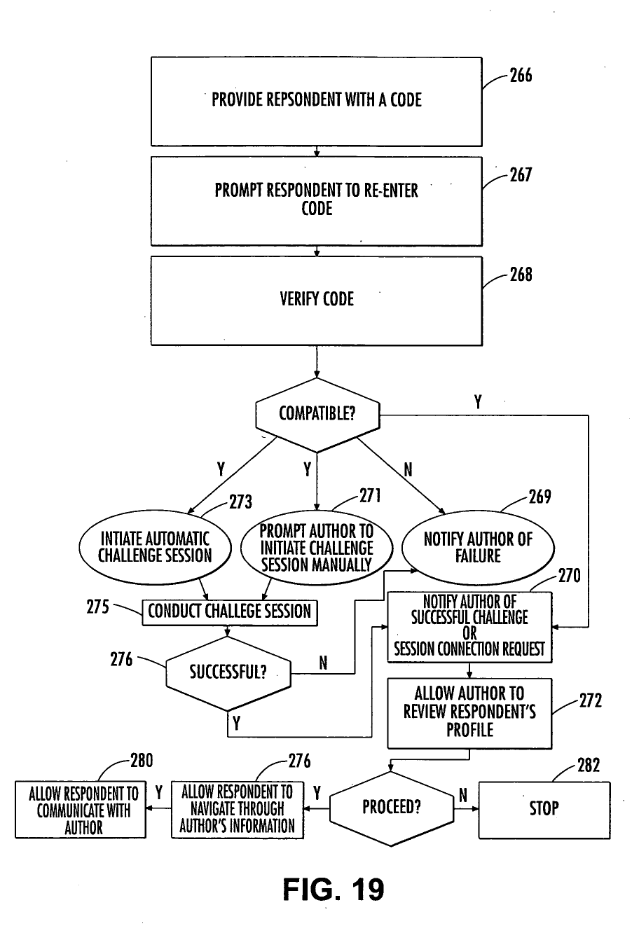

Referring now to FIG. 19, at the server side of the MDS 220, the server 22 preferably executes the following steps when a respondent activates a connection point indicia from a website. At step 266, server 22 preferably provides the respondent with a code. Server 22 preferably prompts the respondent to re-enter the code 267 and verifies that the code conforms with the code that server 22 previously issued. Server 22 preferably further verifies that the connection point indicia the respondent activated to obtain the code matches its associated connection point (step 268). If the re-entered code fails the verification process, a message notifying the author of the failure is preferably issued (step 269), and MDS 220 is preferably configured to terminate further activities. Alternatively, MDS 220 may be configured to provide the respondent multiple chances to re-enter a valid code.

If the re-entered code passes the verification test and if MDS 220 is not configured to run a challenge session automatically or manually, the server 22 may notify the author of a request by the respondent to either contact the author or obtain information about the author(step 270). The author may review the respondent's profile (step 272) and exercise discretion on whether the respondent should be allowed to proceed. If the author decides that the respondent should be allowed to proceed, the respondent may be allowed to navigate through the author's profile (step 276) or initiate communications with the author (step 280). Otherwise, the author may deactivate the session immediately (step 282).

If the server 22 is configured to conduct a manual or automatic challenge session, at step 275, the challenge session protocols described above and shown in FIGS. 10, 11, 12, and 13 are preferably executed. If the respondent completes the challenge session successfully at step 276, the author is preferably notified of the successful session 270. MDS 220 may allow the author to review the profile of the respondent (step 272) and exercise discretion on whether to allow the respondent to proceed. If the author does not want to release any information to the respondent, or if the author does not want to establish any connection with the respondent, the author may deactivate the session immediately (step 282). Otherwise, the author may allow the respondent to navigate through the author's profile (step 276) or initiate communications with the author (step 280). It is noted that, in the preferred embodiment, the author and the respondent may disconnect their communication channel at any time. Communications between the author and the respondent may be conducted via instant messaging programs known in the art, or methods for conducting online chats described above.

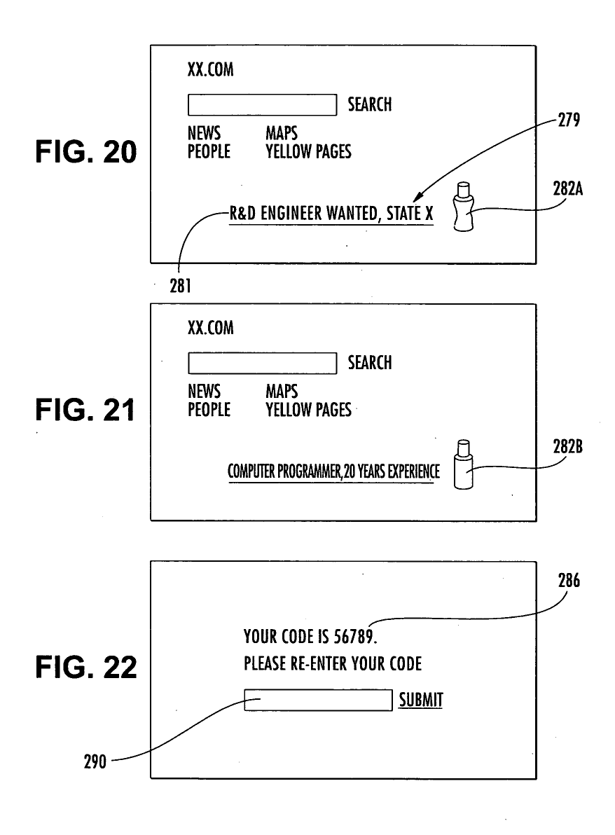

FIGS. 20-23 show various screen displays that may be seen by the author or the respondent during the operation of MDS 220. With reference to FIG. 20, when the respondent navigates a participating internet website, respondent may see a connection point indicia 279, which preferably includes a symbol 282 and a short description 281. A variety of symbols may be used. In the preferred embodiment, MDS 220 preferably uses at least two types of symbols to indicate whether or not a challenge session will be conducted as part of the search process. As examples, bottles with curved bodies (hereinafter “type A”), which is shown in FIG. 20, may be used for connection points that utilize challenge sessions during the search; bottles with substantially straight lower bodies (hereinafter “type B”), which is shown in FIG. 21, may be used for connection points that do not utilize challenge sessions.

Indicia 279 may include a short description 281 that is configured to attract internet users to point and click. The short description 281 may be some indication of the search purpose or a phrase that will likely cause interest to web surfers to click on the indicia. To illustrate, short descriptions may, as examples, be, “R&D Engineer Wanted,” “Computer Programmer With 20 Years Experience,” and the like.

FIG. 22 shows a display that may be seen by a respondent after the respondent clicks on an indicia 279. The display preferably shows a code 286, which may be in the form of numbers, alphabets, symbols, or combinations thereof. The display also preferably includes an entry space 290 where the respondent can enter the newly obtained code 286.

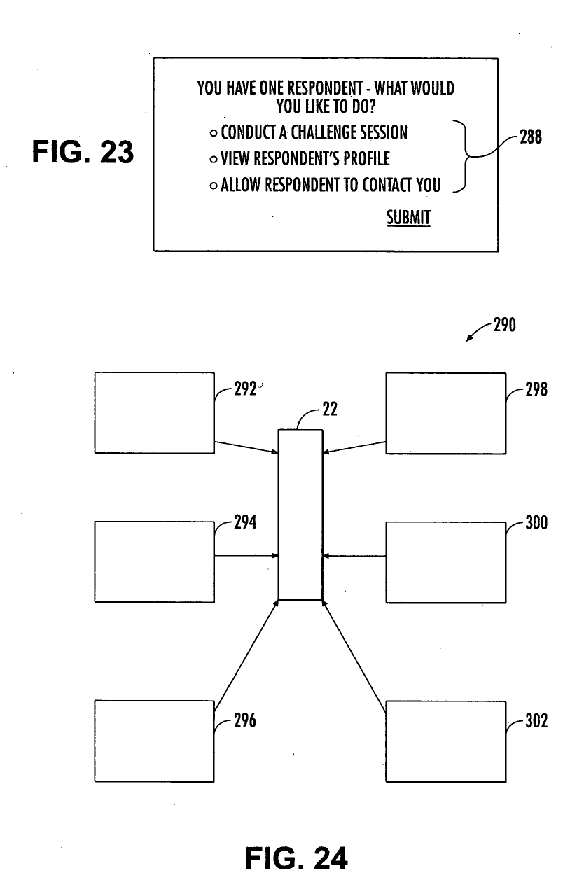

Next, FIG. 23 shows a display the author may see after MDS 220 confirms the validity of the code entered by the respondent. The display preferably provides the author with a plurality of options 288, preferably including manually conduct a challenge session, view respondent's profile, and allow the respondent to contact the author.

It can now be realized that MDS 220 allows a message publisher or author to send a message to an unlimited number of potential message recipients without specifying an exact destination or e-mail address. The message can be posted by MDS 220 at various websites, which may be highly visible and may attract a large number of online subscribers. The message may be linked to an MDS server, which may screen for the desirable online subscribers before the subscribers can contact the publisher. In some applications, MDS 220 can help businesses save resources and time from having to screen people who respond to their advertisements. Consumers can efficiently pick a product or service provider from a plurality of products or service providers being advertised online. MDS 220 can help people effectively find other people online. MDS 220 can also help people effectively search for information online.

Online Conferencing Methods and Devices

With reference now to FIG. 24, another embodiment of a message delivery system MDS 290 is shown. MDS 290 preferably includes a plurality of computers 292, 294, 296, 298, 300, and 302 that are connected to a server 22 via a network, such as the internet. The server 22 preferably provides a real time messenger application to the plurality of computers 292, 294, 296, 298, 300, and 302. MDS 290 is preferably configured to facilitate an online meeting of geographically separated computer users. The users may use a real time messenger application to communicate to each other via the network. To illustrate, a user may compose a message using his or her computer, send the message through the network and the server, and the server may distribute the message to all pre-selected users.

MDS 290 may be used in various applications, such as conducting job interviews. The interview may be conducted by a panel of interviewers, and multiple interviewees may be interviewed for the same position. Users of MDS 290 may be divided into at least two groups according to their status and interests. For example, when MDS 290 is used for conducting job interviews, job interviewers may be classified as Group A and interviewees may be classified as Group B.

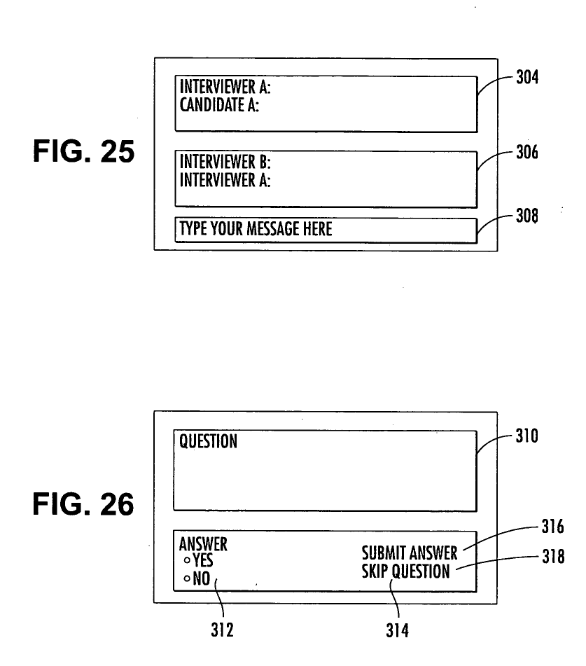

Referring to FIG. 25, each computer 292, 294, 296, 298, 300, and 302 preferably has a display that may be divided into a plurality of sections. For example, a display may be divided into a first section 304 configured to display conversation between members of two groups; a second section 306 configured to display conversation between members of one group; and, a third section 308 configured to display words, phrases, or sentences being composed by the user. Of course, display layouts may vary and still fall within the scope of the invention.

It is noted that MDS 290 is preferably configured to allow group members to have real-time conversations with each other. The conversations may selectively be displayed. For instance, members of Group A may choose to restrict the display of their conversations from members of Group B. Second section 306 of the display may show some written conversations for members of Group A, and may appear blank for members of Group B. Members of a group may also choose to restrict the display of their conversations from other members of the same group.

FIG. 26 shows another display layout preferably for members of a group that do not need to communicate with each other. For instance, in a job interview scenario, job candidates may not need to communicate with each other. Thus, the second section 306 of FIG. 25 may be eliminated and the display of FIG. 25 may be modified to have a first section 310 configured to display a question, a second section 312 configured to show a list of possible answers from which the user may pick, and a third section 314 comprising an answer icon 316 or a skip icon 318, which the user may use when submitting a final answer or when skipping a question.

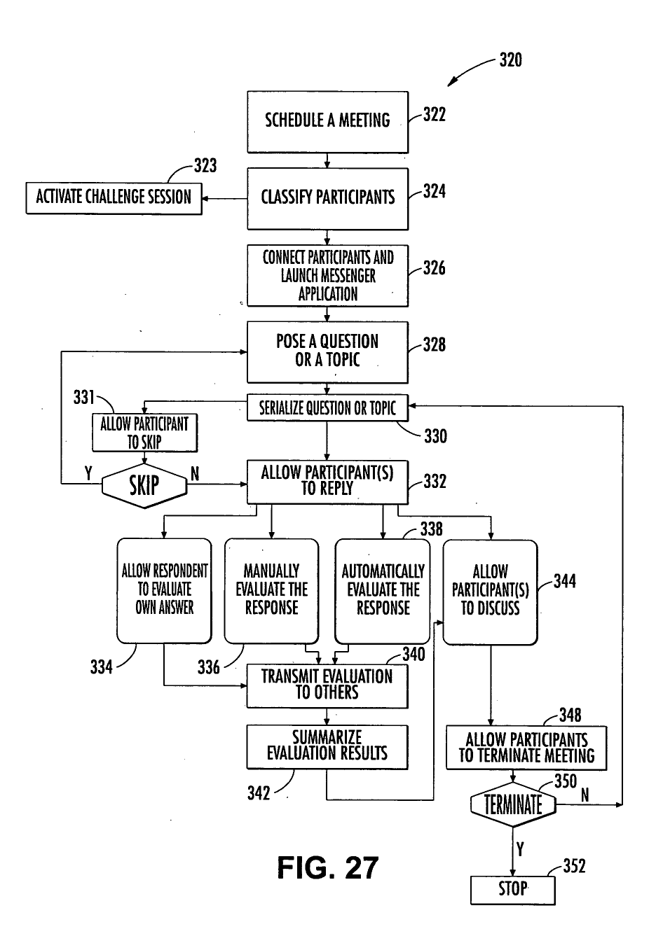

MDS 290 is preferably operated using a protocol 320 shown using a flowchart in FIG. 27. Beginning at step 322, a user of MDS 290 preferably schedules a meeting and informs the participants of the date and time of the meeting. At step 324, the user preferably classifies the participants according to their status or interest. For example, in a job interview setting, the user may group interviewers as Group A and interviewees as Group B. It is noted that MDS 290 may be used in other applications besides job interviews. Other meetings may include corporate meetings, sales meetings, meetings involving litigation, such as depositions, academic meetings, and the like. But for purposes of discussion, the job interview setting will be used as the main example.

The challenge session discussed above may be activated at step 323. Alternatively, MDS 290 may launch a messenger application at step 326. The messenger application preferably provides the participants the ability to communicate online in real time. At step 328, a participant may pose a question or topic and may specify the participant for whom the question or topic is addressed. For instance, in the job interview example, there may be a panel consisting of five (5) interviewers—interviewer A, B, C, D, and E and three (3) job applicants—job applicants 1, 2, and 3. Interviewer A may pose a question and direct the question to job applicant 1.

A pre-formulated list of questions or topic described above may be provided so that the participant may select from the list and may not need to formulate a question or topic. In the preferred embodiment, a time-out value is associated with each question or topic. The time-out value assigns a specific time period within which a participant provides a response. If the time-out value is reached and the applicant fails to provide an answer, the question or topic is preferably considered as having been skipped by the applicant.

Also in the preferred embodiment, at step 330, the questions or topics are preferably assigned with a reference number with assigned priority and MDS 220 is preferably configured to transmit the questions or topics according to their reference number priority. Establishing an order in which the questions are asked ensures that a participant may be asked only one question at a time. Additionally, the questions or topics may not be posed to a participant before he or she has skipped the question, before the participant provided an answer, or before the time-out value is reached.

Next, at step 332, the participant for whom the question or topic was addressed (“addressed participant”) may formulate an answer. It is noted that a pre-formulated list of answers may also be provided to the addressed participant. The addressed participant may also choose to skip the question or topic 331. If the addressed participant chooses to skip the question or topic, the protocol preferably loops back to step 328.

If the addressed participant replied to the question or topic, he or she may evaluate his or her own answer (step 334). This feature may provide the participant a chance to explain to an evaluator why he or she chose to answer in a particular manner. This feature may further allow an evaluator to find out how the participant comprehended the question. Preferably, the participant's self-evaluation does not directly affect the overall participant score.

Alternatively, a group of selected participants may manually evaluate the answer (step 336), or MDS 290 may automatically evaluate the answer (step 340). A range of scores, such as 0-10 (0 indicating poor performance and 10 indicating excellent performance), may be used. The evaluation may be done manually wherein the evaluating participants assign a score with the range of scores. Alternatively, the evaluation may done automatically wherein scores are pre-assigned to certain answers. For instance, a score of 0 may be assigned to a wrong answer or when a participant chose to skip a question. A score of 10 may be assigned to a correct answer.

The evaluation results may be transmitted to a pre-selected group of participants (step 340), and the evaluation results may be summarized (step 342). The summary may include a table that has the participants identification, a listing of scores from each evaluator for each question or topic posed, and a total score. The table may appear as follows:

| | Interviewer 1 | Interviewer 2 | Interviewer 3 | Total Score |
|---|---|---|---|---|
| Candidate 1 | 4 | 0 | 0 | 4 |
| Candidate 2 | 10 | 0 | 0 | 10 |
| Candidate 3 | 0 | 0 | 0 | 0 |
| Candidate 4 | 0 | 0 | 0 | 0 |

The pre-selected group of applicants to whom the table or the results are transmitted may have a common interest. For example, in the job interview scenario, the evaluation results may be transmitted to the panel of interviewers only and not to the job applicants.

Next, the participants who received the evaluation (hereinafter “evaluating participants”) may be allowed to discuss the answer and the evaluations (step 344). For instance, in the job interview scenario, the panel of interviewers may be allowed to discuss job applicant A's answer and evaluation. At step 348, the evaluating participants may choose to terminate the meeting. For instance, in the job interview scenario, if the evaluating participants see that the job applicant clearly does not possess the requisite educational background or the job applicant clearly does not meet the moral character requirement of the interviewing entity, then the evaluating participants may choose to terminate the meeting. If the evaluating participants terminate the meeting, MDS 290 preferably closes the messenger application. If the evaluating participants do not terminate the meeting, the protocol preferably loops back to step 328 where the evaluating participants may pose another question or topic to the addressed participant.

Where the embodiment of MDS 290 is used to conduct a single interview of multiple job applicants, MDS 290 preferably allows the interview panel to terminate connections of job applicants individually. That is, a connection with one job applicant may be terminated while the connection with the other job applicants may be preserved, and the interview session may be continued. The termination of an interview session of a job applicant is preferably kept private to that applicant. The remaining applicants with whom the same interview session is being conducted are preferably not informed of any interview session termination.

It can now be realized that certain embodiments of the present invention provide the feasibility of a meeting between geographically separated parties. Certain embodiments of the present invention allow interviews of various candidates to be conducted in one single interview, which may further be conducted in a manner that is not known to all candidates that other candidates are being interviewed at the same time. Certain embodiments allow parties of the same interest to communicate with each other during a meeting without the party having a different interest knowing about the contents of the communication.

Another advantage from certain embodiments of the present invention is that they allow people of diverse backgrounds to meet online and in real-time, where they can share their perspectives. For example, in the job interview scenario, a representative from a human resources department (“HR”)and a highly-technical person from a research and development department of a company may interview a job applicant, and both the HR representative and the technical person can evaluate the job applicant in real-time from both perspectives.

Another advantage is that parties can terminate the meeting with a specific party at any time. Yet another advantage is that conference facilitated by the present invention may be conducted online without incurring long-distance tolls.

Although the description above contains many specifications, these should not be construed as limiting the scope of the invention but as merely providing illustrations of some of presently preferred embodiments of this invention. For example, the individual steps in implementing certain aspects of the invention do not have to be conducted in any one particular computer. The steps can be conducted on the author's computer, on the subscriber's computer, a public shared computer, a server, or on the combination of any of these computers. Certain log in procedures discussed above may also be eliminated. Thus, the scope of the invention should be determined by the appended claims and their legal equivalents rather than by the examples given.

1. A method of facilitating online communications between parties, the method comprising:
(A) allowing at least one message author to compose a message and a description of the purpose for sending the message;
(B) defining at least one message type according to the message purpose description;
(C) allowing at least one potential message recipient to enter a profile, the profile comprising an indication of the type of message the potential message recipient desires to receive;
(D) storing the potential message recipient profile into at least one database;
(E) allowing the message author to compose a criteria for determining the potential message recipient to receive the message author's message purpose description;
(F) processing the criteria with the potential message recipient profile stored in the database;
(G) sending the message purpose description to at least one potential message recipient that meets the criteria;
(H) allowing the message author to compose at least one question and set at least one acceptable answer that corresponds to the question;
(I) inviting the potential message recipient that meets the criteria to answer at least one question;
(J) allowing the potential message recipient to answer at least one question;
(K) evaluating the potential message recipient's answer based on the acceptable answer; and
(L) allowing the potential message recipient to access the message depending on the success of the potential message recipient in answering the question.

2. The method of claim 1, wherein the message includes contact information of the message author.

3. The method of claim 1, further comprising:
(A) creating a template of questions;
(B) storing said template of questions; and
(C) providing said template to the message author.

4. The method of claim 3, further comprising:
(A) creating a template of answers;
(B) storing said template of answers; and
(C) providing said template to the potential message recipient who meets the criteria.

5. The method of claim 1, further comprising allowing the potential message recipient to enter a plurality of message types the potential message recipient desires to receive.

6. The method of claim 1, wherein the message purpose description is to find an employee.

7. The method of claim 6, wherein the message comprises contact information of an employer.

8. The method of claim 1, wherein the message purpose description is to find a romance partner.

9. The method of claim 8, wherein the message comprises a meeting schedule and location for the author and the potential message recipient who is successful in answering the question.

10. The method of claim 1, wherein the message purpose description is to find a person whom the author has lost contact.

11. The method of claim 10, wherein the message comprises contact information of the author.

12. The method of claim 10, wherein the message comprises information about a reward for the potential message recipient who is successful in answering at least one answer and who initiates contact with the author.

13. The method of claim 1, further comprising allowing the author to set a schedule for sending the message purpose description to at least one potential message recipient that meets the criteria.

14. The method of claim 13, further comprising configuring the processor to evaluate the answer.

15. A method for facilitating online communications between parties, the method comprising:
(A) allowing at least one message author to compose a message;
(B) allowing the message author to provide a description of the purpose for sending the message;
(C) defining a plurality of message types;
(D) categorizing each message according to the predefined message types;
(E) associating the author's message with a message type;
(F) allowing at least one potential message recipient to enter a profile; the potential message recipient being prompted to include in the profile an indication of the type of message the potential message recipient desires to receive, the message type indication being derived from the plurality of predefined message types; and
(G) matching the author with the potential message recipient based on the author's message and the potential message recipient's profile.

16. The method of claim 15, wherein the message types are based on the purposes of the message.

17. The method of claim 15, further comprising providing at least one message type template.

18. The method of claim 15, further comprising allowing the potential message recipient to define an original message type.

19. The method of claim 15, further comprising allowing the author to define an original message type.

20. The method of claim 15, wherein at least one message type is to find an employee.

21. The method of claim 15, wherein at least one message type is to find a romance partner.

22. The method of claim 15, wherein at least one message type is to find a person whom the author has lost contact.

23. The method of claim 15, further comprising:
(A) allowing the message author to compose at least one question and set at least one acceptable answer that corresponds to the question;
(B) inviting the potential message recipient whose profile substantially matches the author's message type to answer the question;
(C) allowing the potential message recipient to answer the question;
(D) evaluating the potential message recipient's answer based on the acceptable answer; and
(E) allowing the potential message recipient to access the message depending on the success of the potential message recipient in answering the question.

24. A method for facilitating an online search, the method comprising:
(A) allowing at least one potential message recipient to enter a profile, the profile comprising at least one potential message recipient trait;
(B) compiling the potential message recipient profile;
(C) storing the potential message recipient profile into a database;
(D) allowing a author to compose a criteria for picking at least one potential message recipient from the database;
(E) processing the profile in the database with the criteria;
(F) allowing the author to compose at least one question and set at least one acceptable answer that corresponds to the question;
(G) inviting the potential message recipient that meets the criteria to answer at least one question;
(H) allowing the potential message recipient to answer at least one question; and
(I) evaluating the potential message recipient's answer based on the acceptable answer.

25. The method of claim 24, further comprising sending a message to the potential message recipient that meets the criteria.

26. The method of claim 24, further comprising allowing the author to compose a message, the message being configured to be accessible to a potential message recipient who successfully answers the question.

27. The method of claim 26, wherein the protected message contains information about the author's identity and allows the potential message recipient who successfully answers the question to contact the author.

28. The method of claim 24, further allowing the author and the potential message recipient who successfully answers the question to exchange information.

29. A search system comprising:
(A) a network,
(B) at least one computer connected to the network, the computer being configured to gather a user profile, the user profile comprising at least one trait of the user; and
(C) a storage device connected to the computer configured to gather the user profile, the storage device configured to store the user profile;
(D) at least one processor connected to the network, the computer, and the storage device, the processor being configured to allow a author to establish a criteria for picking a user based on the user profile, process the criteria with the user profile from the storage device, invite a qualified user that meets the criteria to a challenge session, and allow the author to pose at least one question to the qualified user.

30. The search system of claim 29, wherein the processor is further configured to accept from the author a protected message, the protected message being configured to be accessible to the user who meets the criteria and successfully answers the question.

31. The search system of claim 30, wherein the protected message contains information about the author's identity and allows the potential message recipient who meets the criteria and successfully answers the question to contact the author.

32. The search system of claim 29, wherein the processor is further configured to allow the author and the potential message recipient who meets the criteria and successfully answers the question to exchange information.

33. A method for conducting an online chat session, the method comprising:
(A) providing a network;
(B) allowing at least two parties to transmit data through the network; and
(C) providing at least one message template to at least one of the two parties, wherein the party having access to the message template may select the template to create a message and transmit the message created from the template to the other party.

34. The method of claim 33, further comprising displaying the message template on a computer monitor of the party having access to the template.

35. The method of claim 33, further comprising providing a message template wizard, wherein a party may build the message template using the wizard.

36. The method of claim 33, further comprising allowing a party to compose a question or an answer and caching said question or answer.

37. The method of claim 33, wherein the message template is either a question or an answer to a question.

38. The method of claim 33, wherein the message template is a topic for a dialog.

39. A chat system comprising:
(A) a network,
(B) at least one server connected to the network; and
(C) a plurality of computers connected to the network and the server, each computer comprising:
(a) at least one input device, the input device being configured to allow a user to enter a message;
(b) at least one display device, the display device configured to display a dialog from at least two users, the dialog comprising at least one message from an author and at least one message from a recipient, the display device further being configured to display a plurality of templates, each template being usable by a user to carry on the dialog and wherein the templates are configured to save the user from having to formulate an original message to use during the dialog.

40. The chat system of claim 39, wherein the template comprises a list of questions a party to the dialog can select from and transmit to the other party.

41. The chat system of claim 40, wherein the template comprises a list of answers corresponding to a particular question from the list of questions wherein a party to the dialog can select from the list of answers and transmit to the other party.

42. The chat system of claim 39, wherein the template comprises a list of topics a party to the dialog can select from and transmit to the other party.

43. A method for facilitating online communications between parties, the method comprising:
(A) publishing a first message on at least one website;
(B) allowing an online subscriber to respond to the first message;
(C) posing a question to the online subscriber;
(D) allowing the online subscriber to answer the question;
(E) evaluating the online subscriber's answer; and
(F) allowing the online subscriber to see a second message depending on the success of the subscriber's answer.

44. The method of claim 43, wherein the first message comprises a description of a benefit the online subscriber may obtain.

45. The method of claim 43, wherein the second message comprises the author's contact information.

46. The method of claim 44, wherein the second message comprises an instruction on how to obtain the benefit.

47. The method of claim 43, wherein at least one question asks the online subscriber to provide at least a partial description of himself, herself, or the entity he or she is representing.

48. The method of claim 43, further comprising allowing the author to exercise discretion in granting access to the second message to the online subscriber.

49. The method of claim 43, wherein the first message is in a form of an online advertisement.

50. A conferencing device comprising;
(A) a network,
(B) at least one server connected to the network;
(C) a first computer connected to the network and the server, the first computer being configured to be used by a first user, the first computer comprising a first input device being configured to allow the first user to enter a message;
(D) a second computer connected to the network and the server, the second computer being configured to be used by a second user, the second computer comprising a second input device being configured to allow the second user to enter a message;
(E) at least one real time messenger program connected to the network and usable by the first and the second user, the real time messenger program being configured to allow the first user and the second user to have a dialog between each other; and
(F) a third computer connected to the network and the server, the third computer being configured to be used by a third user, the third computer comprising a third input device being configured to allow the third user to enter a message, wherein the first, second, and third user may have a dialog between each other and wherein the server is configured to allow two of the three users to have a dialog that is private from the remaining user while maintaining live communication lines between all three users.

51. The system of claim 50, wherein the server is configured to pose a question to a user, accept an answer from the user, and evaluate the answer.

52. The system of claim 50, wherein the server is configured to accept a question from the first user, transmit said question to the second user, accept an answer from the second user, and transmit the answer to the first user.

53. The system of claim 50, wherein a user may be terminated from the dialog at any time.

54. The system of claim 51, wherein the server is configured to provide an evaluation of a user to at least one of the remaining users.

55. The system of claim 50, wherein at least one of the first, second, or third computer may be used by an interviewer and the remaining computers may be used by interviewees.

56. The system of claim 55, wherein the server is configured to provide an evaluation of an interviewee to the interviewer.

57. The system of claim 56, wherein the server is configured to provide an evaluation of at least two interviewees to the interviewer so that the interviewer may compare the interviewees.

58. The system of claim 55, wherein the system is configured to conduct a single interview session of at least two interviewees.

59. The system of claim 50, wherein information about the activities of at least one of the first, second, or third computer is blocked from at least one of the computer users.

60. A method of facilitating online communications, the method comprising:
(A) allowing a message initiator to compose a message, the message comprising information that may inform or may be of benefit to a potential message recipient;
(B) storing the message;
(C) associating the stored message with an indicia;
(D) displaying the indicia on a website, the indicia being configured to be activated by an internet subscriber when the internet subscriber selects the indicia;
(E) allowing the subscriber to activate the indicia;
(F) screening for at least one qualified subscriber; and
(G) selecting at least one subscriber to receive the message.

61. The method of claim 60 wherein the step of screening for qualified subscriber comprises asking the subscriber at least one question, allowing the subscriber to answer the questions, and evaluating the subscriber' answer.
